(19) United States
(12) Patent Application Publication
(10) Pub. No.: US 2014/0082611 A1
(43) Pub. Date: Mar. 20, 2014

(54) APPARATUS AND METHOD FOR MONITORING APPLICATION PERMISSIONS

(71) Applicant: SAMSUNG ELECTRONICS CO. LTD., Suwon-si (KR)

(72) Inventors: Zhiyun LI, Kenmore, WA (US); Pankaj KUMAR, Seattle, WA (US)

(73) Assignee: Samsung Electronics Co. LTD., Suwon-si (KR)

(21) Appl. No.: 13/623,382

(22) Filed: Sep. 20, 2012

(51) Int. Cl. G06F 9/445

(52) U.S. Cl. 717/178; 717/174

(57) ABSTRACT

An apparatus and a method for monitoring an application to be installed on a mobile device are provided. The apparatus includes a display unit, a monitoring unit for determining whether a user has selected an application for installation in the mobile device, the application requiring at least one permission predetermined by the user, and a controller for controlling the mobile device to present an alert to the user when the user selects the application, wherein each of the at least one permission represents an action performed by an application.

### BACKGROUND OF THE INVENTION

1. Field of the Invention

The present invention relates to an apparatus and method for mobile applications. More particularly, the present invention relates to an apparatus and method for monitoring mobile application permission settings.

2. Description of the Related Art

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

Many of these features are offered to the user through mobile applications. Some applications come pre-installed on the mobile device, while other applications may be downloaded through an application store provided by the device manufacturer, wireless carrier, or a third party. Application stores typically allow the user to see a product description, screenshots, user reviews, and the like. Some application stores also show the user what permissions the application will need.

FIG. 1 illustrates an operating system screen showing application permissions according to the related art.

Referring to FIG. 1, permissions represent actions which an application needs to be able to perform in order to operate. These actions are typically actions which implicate the user's privacy or which generate potential security concerns. These actions include accessing the user's contact list or other personal information stored on the mobile device, communicating over a network, transmitting user data to a remote server, determining a location via the mobile device's location services, accessing the mobile device's operating system, and reading or writing data to or from storage. The user may determine what permissions an application is requesting via the application store prior to downloading the application, or from a setting menu after downloading the application. FIG. 1 illustrates an example of application permissions displayed in a setting menu.

While some permissions raise significant privacy and security issues, such as the ability to control the mobile device or to access the user's personal information, other permissions are not so important. However, application stores according to the related art do not differentiate between important permissions and less-important permissions, instead listing the permissions without regard to their importance. This makes it difficult for the user to readily distinguish the important permissions from the others. Moreover, the list of permissions is typically displayed on a confirmation screen just prior to beginning the application download, at a point when it is easy for the user simply to confirm the installation and begin the download process while ignoring the permission information. Accordingly, the user is often unaware of the specific permissions granted to an application, even when the user may wish to know this information.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for monitoring of application permissions in a mobile device.

In accordance with an aspect of the present invention, a mobile device is provided. The mobile device includes a display unit, a monitoring unit for determining whether a user has selected an application for installation in the mobile device, the application requiring at least one permission predetermined by the user, and a controller for controlling the mobile device to present an alert to the user when the user selects the application, wherein each of the at least one permission represents an action performed by an application.

In accordance with an aspect of the present invention, a method for managing application downloads in a mobile device is provided. The method includes receiving a list of permissions to be monitored, receiving a request to download an application, and when the application requires permissions included on the list of permissions to be monitored, controlling the mobile terminal to present an alert to the user.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an operating system screen showing application permissions according to the related art;

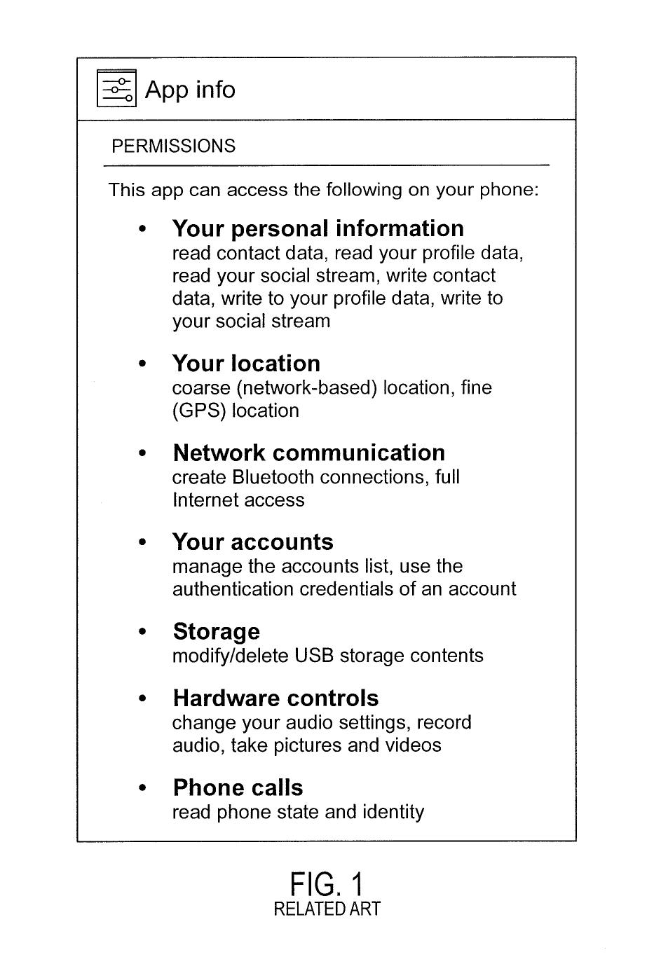

FIG. 2 illustrates a mobile device according to an exemplary embodiment of the present invention; and

FIG. 3 is a flowchart of a method for monitoring applications according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

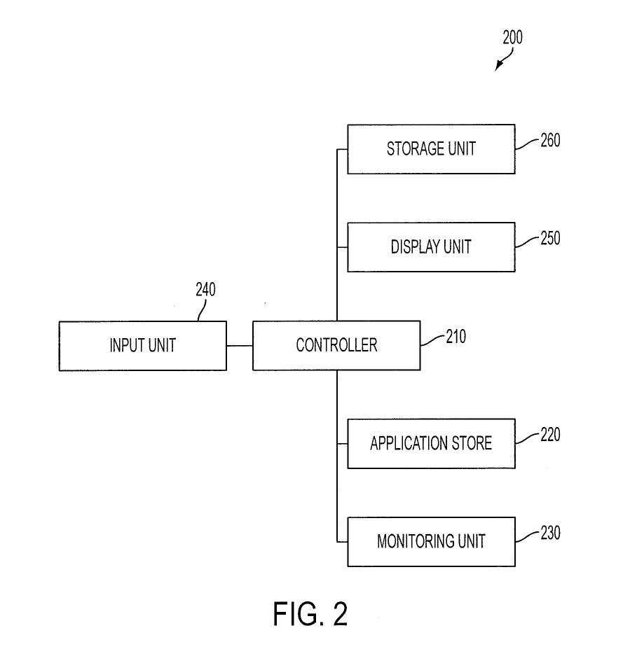

FIG. 2 illustrates a mobile device according to an exemplary embodiment of the present invention

Referring to FIG. 2, a mobile device 200 includes a controller 210, an application store 220, a monitoring unit 230, an input unit 240, a display unit 250, and a storage unit 260. The mobile device 200 may include additional units not shown here for the purposes of clarity, such as a camera, GPS unit, and the like. The application store 220 and the monitoring unit 230 may be implemented as software code executed by the controller 210. In this case, the code corresponding to the application store 220 and the monitoring unit 230 may be stored in the storage unit 260.

The controller 210 controls the overall operations of the mobile device 200, and executes an operating system (not shown) as well as various applications and the application store 220. The operating system may be any operating system capable of running on a mobile device, such as iOS™, Android™, or Windows Phone™. The monitoring unit 230 may be a part of the operating system, a separate application, or may be integrated into the application store 220. The controller 210 also executes the monitoring unit 230 to determine whether or not an application is requesting permissions selected for monitoring by the user.

The monitoring unit 230 displays an alert dialog box or other notification when the user selects an application from the application store 220 that employs permissions selected by the user. To select the permissions to be monitored, the user executes the monitoring unit 230, either by selecting an icon, performing a specific touch action, selecting a menu item, or other action. For example, when the monitoring unit 230 is a component of the application store 220, this functionality may be selected via a menu item or icon within the application store 220.

When the monitoring unit 230 is a component of the operating system, the user may select the permissions to be monitored via a settings menu provided by the operating system. These settings (or preferences) menus typically provide a centralized location to view and modify system-wide settings. When the monitoring unit 230 is part of the operating system, the functionality of the monitoring unit 230 may accordingly be controlled by settings within the settings menu.

When the user executes the monitoring unit 230, the monitoring unit 230 presents a list of permissions to the user. The user may select one of the permissions to obtain more information about the particular actions granted by that permission, or to inform the monitoring unit 230 that a particular permission is to be monitored. The user may indicate that a permission is to be monitored by selecting a checkbox or other user interface element. However, it is understood that any mechanism for selecting the preferences may be employed.

The various permissions may also be presented as belonging to one or more groups of permissions corresponding to the type of the permissions. For example, the permissions may be grouped into “account” permissions relating to the user's data, “sensor” permissions related to accessing particular sensors of the mobile device (e.g., a camera, accelerometer, GPS), or “admin” permissions relating to administration of the device. A particular permission may belong to one or more groups according to the nature of the permission. By selecting one of the groups, the user may instruct the monitoring unit 230 to monitor all of the permissions in the selected group. If the user does not wish to monitor all of the permissions in a group, the user may still have the ability to select individual permissions within one or more groups for monitoring.

The monitoring unit 230 stores preference information identifying the permissions to be monitored in the storage unit 260. The preference information may be stored in the form of a list of permissions to be monitored. Subsequently, when the user selects an application in the application store 220, if the selected application employs permissions specified in the preference information, a dialog box or other information is displayed to the user to inform the user that the application employs permissions indicated in the preferences.

The monitoring unit 230 may alert the user via a dialog box displayed prior to installing the application. However, other forms of alerts or indications may be used in addition to, or instead of, a dialog box. For example, permissions that are specified in the preferences may be highlighted in another color or with an icon. Similarly, the dialog box could be presented to the user when the user first selects the application or selects an install button. In addition, an audio alert could be presented to the user.

The particular timing and format of the alert may vary according to the design of the application store 220. For example, some application stores employ a two-stage process for downloading applications. In the first stage, the user is presented with a product description page including screen shots, a product description, user reviews, the application cost, and the like. When the user selects an “Install” or “Purchase” button, a second page is displayed, which may include a list of the permissions requested by the application, purchase information (such as credit card information and price), and a confirmation button. The download (and purchase, if the application is a paid application) does not begin until the user presses the confirmation button to authorize the purchase (if needed) and initiate the download process. The Google Play Store™ is one example of an application store employing a two-stage system.

In these two-stage systems, the dialog or alert may be displayed when the user selects the install button from the product description page, or when the user selects the confirmation button to initiate the download. Similarly, a notification could be added to the product description page when the monitoring unit 230 determines that the application would request a permission that is included in the list of permissions to be monitored. Similarly, while the user browses available applications in the app store, an icon or other highlight could be displayed next to applications which would employ permissions selected by the user for monitoring.

In the one-stage system, only one screen is presented to the user. Like the two-stage system, this screen includes product description, price, user reviews, screenshots, and the like. The screen may also include a list of permissions requested by the application. When the user presses an “Install” button, a confirmation dialog may be presented to the user, after which the user is charged for the purchase and the download begins. The Apple™ App Store is an example of an application store employing a one-stage system.

In a one-stage system, the dialog or alert may be displayed as part of the confirmation dialog or as a separate dialog. The product description screen may also include a notification that the application requests permissions that is included in the list of permissions to be monitored. Of course, the notification mechanisms described herein are merely exemplary; additional notification schemes may also be employed.

The monitoring unit 230 may execute to determine whether an application selected by the user in the application store 220 uses permissions identified in the preferences. However, as described above, the functionality of the monitoring unit 230 may be integrated into the application store 220.

In addition to monitoring downloads from the application store 220, the monitoring unit 230 may also monitor downloads from other sources, such as from a desktop computer or an external server. In this case, the monitoring unit 230 may identify the permissions when the application is first downloaded or is first executed on the mobile device 200.

The display unit 250 may be provided as a Liquid Crystal Display (LCD). In this case, the display unit 250 may include a controller for controlling the LCD, a video memory in which image data is stored and an LCD element. If the LCD is provided as a touch screen, the display unit 250 may perform a part or all of the functions of the input unit 240. As described above, the display unit 250 displays an alert to the user when an application employing the permissions identified by the user is selected in the application store 220.

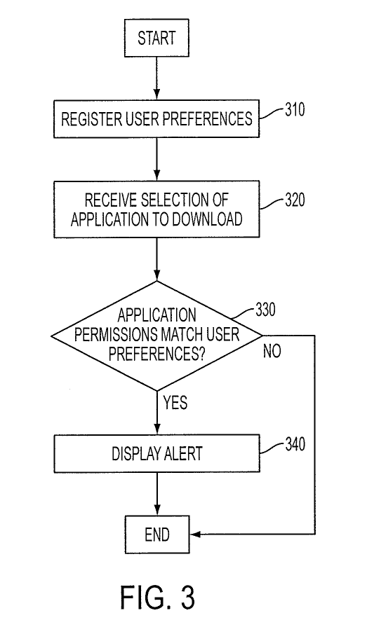

FIG. 3 is a flowchart of a method for monitoring applications according to an exemplary embodiment of the present invention.

Referring to FIG. 3, the user registers permissions to be monitored in step 310. The monitoring unit 230 receives the permissions to be monitored and stores the permissions as user preferences in the storage unit 260.

Subsequently, in step 320, the user selects an application to be installed in the mobile terminal. This may occur through the use of the application store 220 or from some other location.

In step 330, the monitoring unit 230 determines whether the selected application requests permissions included in the user preferences of permissions to be monitored. If the selected application does not include any of these permissions, then the monitoring unit 230 takes no action. Instead, a product description page may be displayed to the user, a confirmation page may be displayed to the user, the download may begin, or some other typical action may occur.

If the monitoring unit 230 determines that the selected application does request permissions included in the user preferences, the monitoring unit 230 displays an alert to the user in step 340. The alert may be a dialog box, an alert sound, or may include additional information included in a product description page or confirmation page.

According to exemplary embodiments of the present invention, the user is notified before downloading any application that requests permissions selected by the user. As a result, the user is able to more closely monitor the permissions requested by applications installed in the mobile device. The user's security and privacy are therefore enhanced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile device comprising:
a display unit;
a monitoring unit for determining whether a user has selected an application for installation in the mobile device, the application requiring at least one permission predetermined by the user; and
a controller for controlling the mobile device to present an alert to the user when the user selects the application,
wherein each of the at least one permission represents an action performed by an application.

2. The mobile device of claim 1, wherein the controller controls the display unit to display a dialog box when the user selects the application.

3. The mobile device of claim 1, wherein the controller controls the display unit to display a notification when the user selects the application.

4. The mobile device of claim 1, further comprising:
an application store,
wherein the controller controls the mobile device to present the alert to the user when the user selects the application for installation via the application store.

5. The mobile device of claim 1, further comprising:
an input unit; and
a storage unit for storing a list of the at least one permission selected by the user for monitoring,
wherein the monitoring unit receives user input selecting the at least one permission for monitoring, and stores the list of the at least one permission in the storage unit.

6. The mobile device of claim 5, wherein the at least one permissions are arranged into one or more groups,
wherein the monitoring unit receives user input selecting at least one of the groups, and stores a list of the at least one permission corresponding to the selected groups in the storage unit.

7. A method of managing application downloads in a mobile terminal, the method comprising:
receiving a list of permissions to be monitored;
receiving a request to download an application; and
when the application requires permissions included on the list of permissions to be monitored, controlling the mobile terminal to present an alert to the user.

8. The method of claim 7, wherein the controlling of the mobile terminal to present the alert to the user comprises controlling the mobile terminal to display a dialog box.

9. The method of claim 7, wherein the controlling of the mobile terminal to present the alert to the user comprises controlling the mobile terminal display all permissions used by the application and to highlight any displayed permissions that are included in the list of permissions to be monitored.

10. The method of claim 7, wherein the receiving of the request to download the application comprises receiving a request to download the application via an application store installed in the mobile device.

11. The method of claim 7, wherein the receiving of the request to download the application comprises receiving a selection of the application via an application store installed in the mobile device.
